(19) United States
(12) Patent Application Publication
(10) Pub. No.: US 2017/0233919 A1
(43) Pub. Date: Aug. 17, 2017

(54) WASHING MACHINE

(71) Applicant: Dongbu Daewoo Electronics Corporation, Seoul (KR)

(72) Inventor: Jong Jin LEE, Seoul (KR)

(21) Appl. No.: 15/287,587

(22) Filed: Oct. 6, 2016

(30) Foreign Application Priority Data
Feb. 15, 2016 (KR) 10-2016-0017482

(51) Int. Cl. D06F 25/00; D06F 33/02; F26B 11/02; D06F 39/02

(52) U.S. Cl. CPC D06F 25/00; D06F 39/028; D06F 33/02; F26B 11/028

(57) ABSTRACT

A washing machine using an air discharge part disposed next to a detergent container to reduce humidity of the air flow exiting from the tub during a drying process. Both the air discharge part and the detergent container are contained in an accommodation part. The air discharge part can be maintained at a low temperature by washing water passing through the detergent container. The air discharge part includes rows of ribs on which water vapor in the air flow can condense due to the low temperature. The air discharge part is disposed on an opposite side of the washing machine to the electrical supplying component, thereby preventing water condensation on the electrical supplying component when the air flow is exhausted from the air discharge part.

### CROSS-REFERENCE TO RELATED APPLICATION

This application is based on and claims priority from Korean Patent Application No. 10-2016-0017482, filed on Feb. 15, 2016, the disclosure of which is incorporated herein in its entirety by reference for all purposes.

### TECHNICAL FIELD

Embodiments of the present disclosure relate to washing machines, and more particularly to, a drying mechanism in washing machines.

### BACKGROUND OF THE INVENTION

A washing machine is an apparatus used for washing and cleaning laundry by friction between the laundry and washing water. During operation, a water tub containing the laundry rotates to generate the friction. Typically, a drum washing machine cleans laundry by lifting and dropping the laundry while the washing tub rotates; while a vertical-shaft washing machine cleans laundry by generating a strong water flow through rotation of a washing tub.

A washing machine may be integrated with a drying system that can dry washed laundry, commonly known as all-in-one washer/dryer or washer-dryer. The drying system may heat up air and supply heated air to a rotating tub which accommodates washed laundry. Based on a user's selection, a washer-dryer may perform only a drying operation or to perform a drying operation combined with a washing operation.

A washer-dryer includes an air discharge part configured to discharge humid air resulted from a drying process. In the related art, the air discharge part is disposed on the rear housing of the washer-dryer.

However, usually electricity supply components, such as a distribution board, a power supply cable and the like, are also installed on the rear housing. As the air discharged from the air discharge part contain moisture, water droplets tend to form on the electricity supply components, posing a high risk of short circuit or even a fire accident.

### SUMMARY OF THE INVENTION

Accordingly, embodiments of the present disclosure provide a washing machine capable of safely exhausting humid air.

According to an embodiment of the present invention, a washing machine includes a tub configured to accommodate washing objects; a drying system configured to discharge a vapor-containing air exiting from the tub, which is generated while drying the washing objects; a detergent container configured to store a detergent for washing the washing objects; and a accommodation part configured to accommodate the detergent container. The accommodation part includes an air discharge part configured to condense water vapor contained in the vapor-containing air into a liquid state.

Further, the washing machine further includes a washing water supply unit configured to supply washing water introduced from the outside into the tub. The detergent container is coupled to the washing water supply unit.

Further, the air discharge part includes a first rib portion formed to extend in a first direction and a second rib portion formed to extend in a direction differing from the first direction.

Further, the air discharge part is disposed on a side of the detergent container.

Further, the air discharge part includes an air outflow port from which the water vapor passing through the air discharge part is discharged. The air outflow port is disposed below the detergent container.

Also in one embodiment, a washing machine includes: a tub configured to accommodate washing objects; a drying system configured to discharge vapor-containing air that is flowing from the tub, which is generated while drying the washing objects; a detergent container configured to store detergent for washing the washing objects; and an accommodation part configured to accommodate the detergent container, the accommodation part including an air discharge part configured to discharge at least a part of the vapor-containing air. At least a part of the vapor-containing air is introduced from an air inflow port disposed in one end portion of the air discharge part. Water vapor contained in the air can be condensed in the air discharge part. As a consequence, air discharged to the outside has significantly reduced humidity and so water condensation on the electricity supplying components can be reduced or eliminated. This advantageously alleviates the risk of short circuits or any accidents related thereto.

### BRIEF DESCRIPTION OF THE DRAWINGS

FIG. 1 is a perspective view illustrating an exemplary washing machine according to one embodiment of the present disclosure.

FIG. 2 is a perspective view illustrating an exemplary detergent container and an exemplary accommodation part in the washing machine illustrated in FIG. 1.

FIG. 3 is an exploded perspective view of the detergent container and the accommodation part illustrated in FIG. 2.

FIG. 4 is an exploded perspective view illustrating an exemplary air discharge part illustrated in FIG. 2.

FIG. 5 illustrates an air flow path in the exemplary air discharge part in FIG. 2 in a bottom view.

FIG. 6 illustrates an air flow path in the exemplary air discharge part in FIG. 2 in a side view.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

One or more exemplary embodiments of the present disclosure will be described more fully hereinafter with reference to the accompanying drawings, in which one or more exemplary embodiments of the disclosure can be easily determined by those skilled in the art. As those skilled in the art will realize, the described exemplary embodiments may be modified in various different ways, all without departing from the spirit or scope of the present disclosure, which is not limited to the exemplary embodiments described herein.

It is noted that the drawings are schematic and are not dimensionally illustrated. Relative sizes and proportions of parts in the drawings may be exaggerated or reduced in their sizes, and a predetermined size is just exemplificative and not limitative. The same reference numerals designate the same structures, elements, or parts illustrated in two or more drawings in order to exhibit similar characteristics.

The exemplary drawings of the present disclosure illustrate ideal exemplary embodiments of the present disclosure in more detail. As a result, various modifications of the drawings are expected. Accordingly, the exemplary embodiments are not limited to a specific form of the illustrated region, and for example, include a modification of a form by manufacturing.

Specific embodiments for realizing the concepts of the present disclosure will now be described in detail with reference to the accompanying drawings.

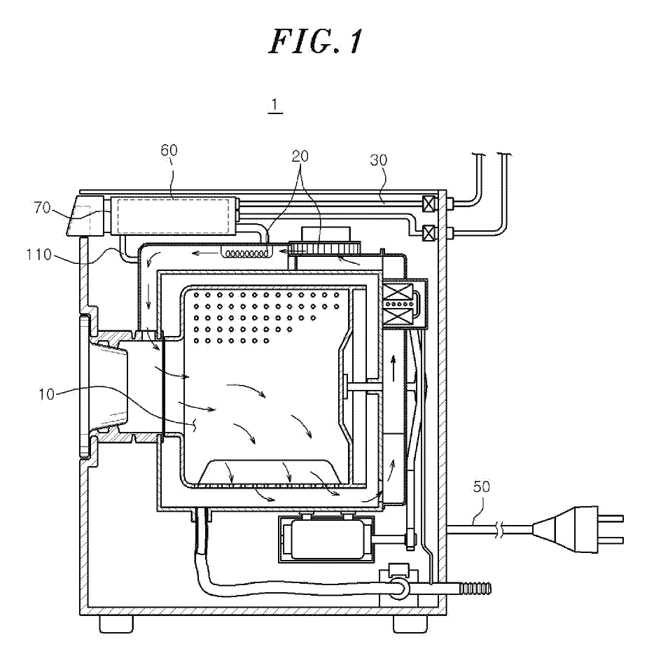

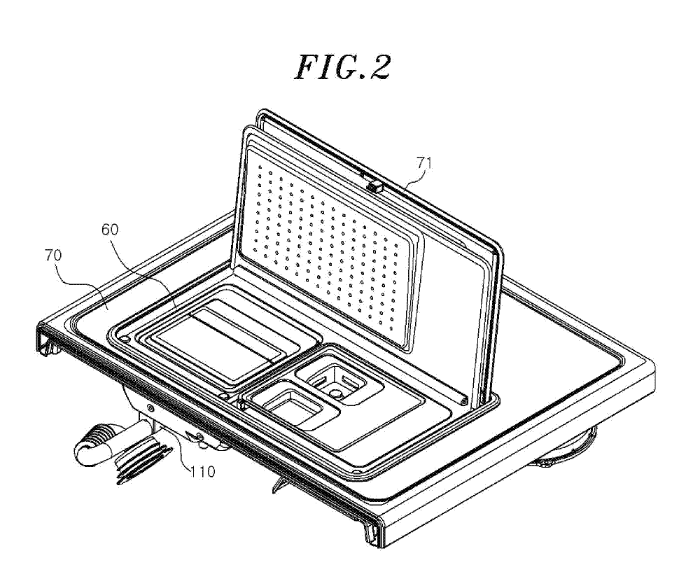

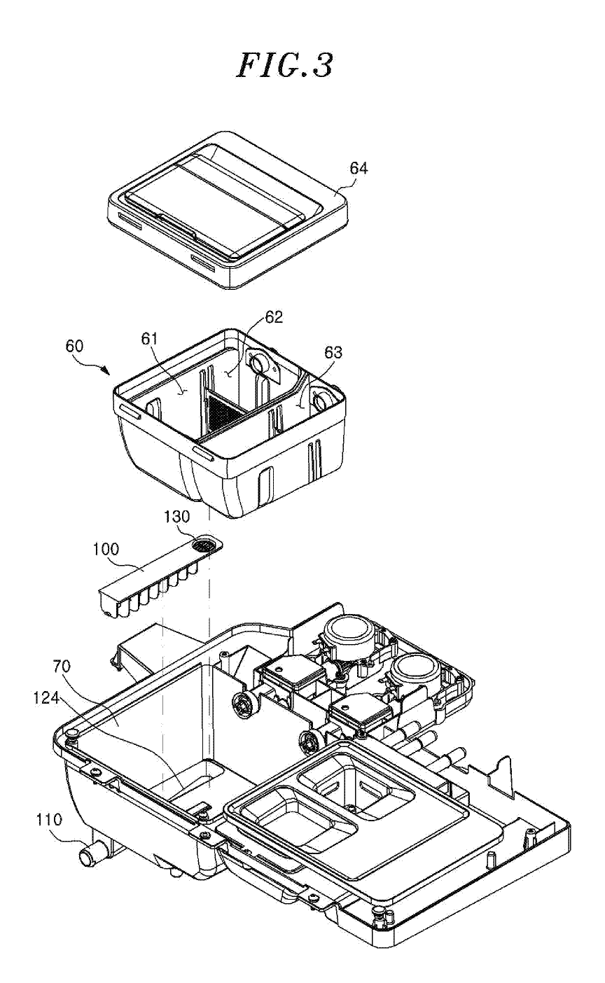

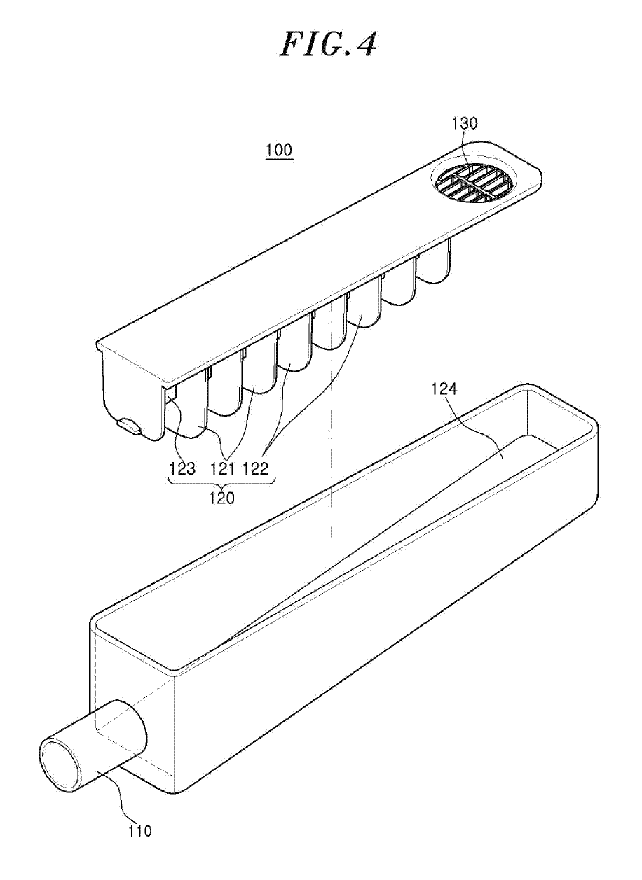

Hereinafter, the configuration of an exemplary washing machine according to one embodiment of the present disclosure is described with reference to FIGS. 1 to 4. FIG. 1 is a perspective view illustrating the exemplary washing machine according to one embodiment of the present disclosure. FIG. 2 is a perspective view illustrating an exemplary detergent container and an exemplary accommodation part in the washing machine illustrated in FIG. 1. FIG. 3 is an exploded perspective view of the detergent container and the accommodation part illustrated in FIG. 2. FIG. 4 is an exploded perspective view of the exemplary air discharge part.

Referring to FIGS. 1 to 4, the exemplary washing machine 1 includes: a tub 10; a drying system 20 configured to dry washing objects accommodated within the tub 10; a washing water supply unit 30 configured to supply washing water to the tub 10; a washing water drain part 40 configured to drain the washing water; an electricity supply device 50 configured to supply electric power form an external power source to the washing machine 1; a detergent container 60 configured to store detergent; and an accommodation part 70 configured to accommodate the detergent container 60. The term “washing objects” used herein broadly encompasses the objects which have been washed and the washing objects which are scheduled to be washed. A washing object may be clothing, bedding or anything suitable to be cleaned or dried in a washing machine.

The tub 10 is coupled to the drying system 20 and the washing water supply unit 30, which will be described in greater detail below. During a drying process, dry air may be supplied from the drying system 20 to the tub 10. During a washing process, washing water may be supplied from the washing water supply unit 30 to the tub 10. Washing water contained in the tub 10 may be drained through the washing water drain part 40.

During a drying process, heated and dry air flows through the tub 10, come into contact with the wet washing object contained in the tub 10, and exits from the tub 10 with added moisture. The drying system 20 may include a circulation part configured to promote circulation of the air in the tub 10, a discharge part configured to discharge the air from the tub, and a heater configured to heat the air in the tub 10. However, the present disclosure is not limited thereto.

The washing water supply unit 30 may supply washing water from an external water source into the tub 10. The washing water supply unit 30 may be coupled to the detergent container 60 and/or the accommodation part 70, which will be described below in greater detail. In other words, the washing water supplied from the washing water supply unit 30 may be supplied to the tub 10 via one or more of the detergent container 60 and the accommodation part 70. The washing water supply unit 30 may include, for example, a pipe or a hose and may be disposed in the upper part of the washing machine 1. However, the present disclosure is not limited thereto.

The washing water drain part 40 may be a port through which the washing water is drained from the tub 10 to the outside of the washing machine 1. For example, the washing water drain part 40 may be located at the lower side of the washing machine 1 and may include a hose.

The electricity supply device 50 supplies electricity to the washing machine 1, for example including a power supply cable and an outlet. However, the present disclosure is not limited thereto.

The washing water supplied from the washing water supply unit 30 may pass through the detergent container 60. Thus, washing water can mix with detergent stored in the detergent container 60 before entering the tub 10. The detergent container 60 may include a washing water inflow port and a washing water outflow port.

The detergent container 60 may include a plurality of compartments 61-63. For instance, a liquid detergent may be stored in the first compartment 61; a powdery detergent may be stored in the second compartment 62; and fabric softener may be stored in the third compartment 63. The detergent container 60 may be disposed in the upper portion of the washing machine 1 for example. However, the present disclosure is not limited thereto.

The detergent container 60 may further include a lid 64. The term “detergent” used herein broadly encompasses various kinds of additives that can be used for washing or drying.

The accommodation part 70 holds the detergent container 60. For example, the accommodation part 70 may have a recess located in the upper portion of the washing machine 1 and may include a cover 71. The accommodation part 70 may be disposed in different location from the electricity supply device 50. Particularly, if the electricity supply device 50 is located one side of the washing machine 1, the accommodation part 70 may be located on an opposite side of the washing machine 1. For example, the electricity supply device 50 may be located on the rear side of the washing machine 1; and the accommodation part 70 may be located in the upper portion of the washing machine 1. The accommodation part 70 may include an air discharge part 100 as described in greater detail below.

Air exiting the tub contains moisture absorbed from wet washing objects and flows toward the air discharge part 100. A drive device (not shown) such as a pump, a motor or the like may be used to push air to flow toward the air discharge part 100.

When air flows through the air discharge part 100, water vapor in the air can be condensed into a liquid state (water droplets). Thereby the air dries. In this configuration, humid air resulting from a drying process may be discharged to the outside of the washing machine 1 at relatively low humidity.

The air discharge part 100 is contained in the accommodation part 70 which is spaced apart from the electricity supply device 50. For example, if the electricity supply device 50 is on the rear side of the washing machine 1 and if the accommodation part 70 is in the upper portion of the washing machine 1, air can be discharged to the upper side of the washing machine 1.

The air discharge part 100 may include an air inflow port 110, a cooling part 120 and an air outflow port 130.

In a drying process, dry air flows through the tub and absorbs moisture from the wet washing objects contained therein, becoming humid air. The humid air flows to the air discharge part 100 through the air inflow port 110 and passes through the cooling part 120. The air inflow port 110 may be disposed at the end of the air discharge part 100. In some embodiments, the air inflow port 110 may be coupled to the bottom of the accommodation part 70 and to the tub 10. However, the present disclosure is not limited thereto. The air inflow port 110 may be coupled to the drying system 20.

The cooling part 120 may include rib members 121, 122 and 123 which may be substantially rectangular-shaped panels protruding from a surface of the air discharge part 100. The first rib members 121 may be disposed on one side (for instance the upper side as shown) of the air discharge part 100. The second rib members 122 may be disposed on the opposite side (for instance the lower side as shown) in parallel with the first rib members 121.

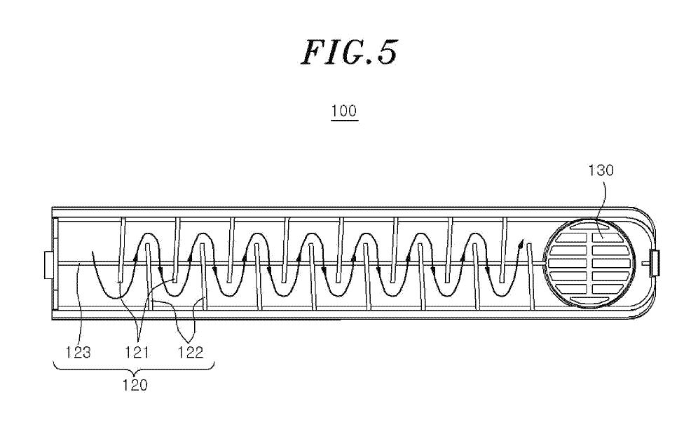

As illustrated in FIG. 5, when an air flow encounters the first rib members 121, it is redirected to the other side of the air discharge part 100 and thus flows downward as shown. Similarly, while flowing downward, the air flow encounters the second rib members 122 and redirected to the upper side with the first rib members 121.

The first rib members 121 and the second rib members 122 interlace with each other. In addition, the first rib members 121 and the second rib members 122 may contact the bottom surface of a cooling part seat portion 124.

The third rib member 123 may be an elongated panel protruding from one side of the air discharge part 100, e.g., from the same side as the first rib members as shown. The third rib member 123 is oriented substantially perpendicular to the first and second rib members 121 and 122. The protruding length of the third rib member 123 from the surface of the air discharge part 100 may be smaller than that of the first and second rib members 121 and 122. Thus, air passing through the first and second rib members 121 and 122 flows toward the opposite side of one surface of the air discharge part 100. For example, if the third rib member 123 is formed to protrude from the upper side of the air discharge part 100 toward the lower side thereof, the air passing through the first and second rib members 121 and 122 flows downward due to the existence of the third rib member 123 protruding from the upper side.

The cooling part 120 may be removed from the air discharge part 100, allowing a user to remove water accumulated thereon.

According to embodiments of the present disclosure,the cooling part 120 provides a complex path for humid air to flow through and thereby dries the air efficiently. Water vapor contained in the humid air can be condensed into a liquid state (water droplets) by the cooling part 120. As moisture accumulates, large water droplets may form, which can be gathered and drained from the air discharge part 100. Condensed water may be drained through a separate drain port coupled to the washing water drain part 40, or may be returned to the air inflow port 110 and then drained from the air inflow port 110.

The cooling part 120 may be removably accommodated within the accommodation part 70. The accommodation part 70 may include a cooling part seat 124. Condensed water may flow toward the cooling part seat 124. The cooling part seat 124 may be inclined downward toward the air inflow port 110 or toward a separate drain port. The inclined surface facilitates the condensed water to flow under gravity.

Dried air is then discharged through the air outflow port 130 and toward the accommodation part 70. For example, the air outflow port 130 may be oriented upward from the bottom of the accommodation part 70. The air outflow port 130 may face the detergent container 60. Furthermore, the air outflow port 130 and the air inflow port 110 may be disposed on opposite sides of the air discharge part 100. In addition, the air outflow port 130 may be disposed in the cooling part 120.

The drying system 20 may perform a drying process following a washing process or it may be performed independent of a washing process. During a drying process, dry air absorbs moisture from wet washing objects and becomes humid air. The humid air may be partially or wholly discharged from the tub 10 toward the air discharge part 100. The humid air may be discharged from the tub 10 during or after the drying process.

The humid air flows into the air discharge part 100 through the air inflow port 110 and passes through the cooling part 120. In the cooling part 120, water vapor contained in the humid air can be condensed on the rib members 121, 122 and 123 and thereby removed from the air.

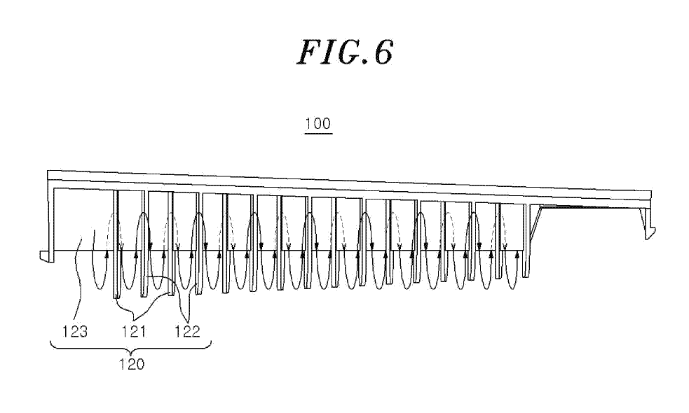

FIG. 5 illustrates a bottom view of the exemplary air discharge part in FIG. 2 and an exemplary air flow path therein. FIG. 6 illustrates a side view of the exemplary air discharge part in FIG. 2 and the exemplary air flow path therein.

Referring to FIG. 5, humid air encounters the first rib members 121 disposed on the upper side of the air discharge part 100 and is redirected toward the lower side. While flowing downward, the air encounters the second rib members 122 disposed on the lower side of the air discharge part 100 and is redirected back upward. Since the first and second rib members 121 and 122 interlace with each other, the air flows in an S-like path due to the first and second rib members 121 and 122. In other words, when the air discharge part 100 is viewed from the lower side, the air flows leftward and rightward back and forth.

Referring to FIG. 6, the third rib member 123 includes an elongated panel that extends across the rows of first and second rib members 121 and 122. It protrudes from one surface of the air discharge part 100. The third rib member 123 causes the air to flow up and down while it passes through the first and second rib members 121 and 122. For example, if the third rib member 123 is formed to protrude downward from the upper side of the air discharge part 100 as illustrated in FIG. 6, air passing through the first and second rib members 121 and 122 is obstructed by the third rib member 123 protruding from the upper side and so flows downward. Since the first and second rib members 121 and 122 are configured to contact the bottom surface of the cooling part seat portion 124, the air moving downward is obstructed by the first and second rib members 121 and 122 and flows upward from the lower side. In other words, when the air discharge part 100 is viewed from one side, air flows upward and downward in a zigzag pattern.

As air flows through the cooling part, water vapor can be condensed on the ribs. As a result, the air exiting the cooling part 120 has reduced humidity and discharged. The air is discharged to the outside of the washing machine through the air outflow port 130 and then a clearance between the detergent container 60 and the accommodation part 70.

The air discharge part 100 is disposed in the accommodation part 70 that is adjacent to the detergent container 60. Since washing water flowing through the detergent container 60 typically has a low temperature, the detergent container 60, the accommodation part 70 and the air discharge part 100, which are proximate to the detergent container 60, can be effectively cooled by the washing water. Thus, the air discharge part 100 can be effectively maintained at a low temperature by the washing water, thereby drying the humid air supplied from the tub through condensation.

Furthermore, according to some embodiments of the present disclosure, the accommodation part 70 and the air discharge part 100 contained therein are spaced apart from the electricity supply device 50, which allows air to be discharged without encountering the electricity supply device 50. This can advantageously prevent water vapor condensation on the electricity supply device 50, and so effectively reduce the risk of short circuit and other types of accidents related thereto.

Although exemplary embodiments of the present disclosure are described above with reference to the accompanying drawings, those skilled in the art will understand that the present disclosure may be implemented in various ways without changing the necessary features or the spirit of the present disclosure.

Therefore, it should be understood that the exemplary embodiments described above are not limiting, but only an example in all respects. The scope of the present disclosure is expressed by claims below, not the detailed description, and it should be construed that all changes and modifications achieved from the meanings and scope of claims and equivalent concepts are included in the scope of the present disclosure.

From the foregoing, it will be appreciated that various embodiments of the present disclosure have been described herein for purposes of illustration, and that various modifications may be made without departing from the scope and spirit of the present disclosure. The exemplary embodiments disclosed in the specification of the present disclosure do not limit the present disclosure. The scope of the present disclosure will be interpreted by the claims below, and it will be construed that all techniques within the scope equivalent thereto belong to the scope of the present disclosure.

What is claimed is:

1. A washing machine comprising:
a tub configured to accommodate washing objects;
a drying system configured to supply an air flow to the tub to dry the washing objects;
a detergent container configured to contain an additive;
an accommodation part configured to accommodate the detergent container and comprising an air discharge part configured to dry air flow exiting from the tub.

2. The washing machine of claim 1, wherein the accommodation part is configured to reduce water vapor in the air flow through condensation.

3. The washing machine of claim 1, wherein the air flow supplied from the drying system is operable to absorb humidity from the washing objects in the tub.

4. The washing machine of claim 1, wherein the drying system is configured to heat air to generate the air flow.

5. The washing machine of claim 1 further comprising:
a washing water supply unit configured to supply washing water to the tub,
wherein the detergent container is coupled to the washing water supply unit.

6. The washing machine of claim 1, wherein the air discharge part comprises a first row of ribs and a second row of ribs.

7. The washing machine of claim 6, wherein the first row of ribs protrude from a first surface of the air discharge part, and the second row of ribs protrude from a second surface of the air discharge part, and wherein the first surface and the second surface of the air discharge part are disposed opposite to each other.

8. The washing machine of claim 7, and wherein the first row of ribs and the second row of ribs are arranged in an interlaced pattern.

9. The washing machine of claim 7, wherein the first row of ribs and the second row of ribs comprise parallel panels.

10. The washing machine of claim 7 further comprising an elongated panel protruding from the first surface of the discharge part, wherein the elongated panel is oriented substantially perpendicular to panels of the first row of ribs.

11. The washing machine of claim 1, wherein the air discharge part comprises an air outflow port disposed below the detergent container.

12. The washing machine of claim 1 further comprising an electricity supply component operable to electrically couple an external power source to the washing machine, wherein the electricity supply component is disposed on an opposite side of the washing machine to the accommodation part.

13. A washing machine comprising:
a tub configured to accommodate washing objects;
a drying system configured to supply an air flow to the tub for drying the washing objects;
a detergent container configured to store an additive;
a washing water supply system configured to supply washing water to the tub; and
an accommodation part configured to accommodate the detergent container, wherein the accommodation part comprises an air discharge part operable to reduce humidity in an air flow exiting from the tub by virtue of condensation, wherein the air discharge part is operable to be maintained at a low temperature by washing water flowing through the detergent container.

14. The washing machine of claim 13, wherein the air discharge part comprises: an air inflow port; ribs extending from inner walls of the air discharge part; and an air outflow port.

15. The washing machine of claim 14, wherein the ribs comprise: a first row of ribs protruding from a first wall of the air discharge part; a second row of ribs protruding from a second wall of the air discharge part, wherein the first row of ribs and the second row of ribs are arranged in an interlaced pattern.

16. The washing machine of claim 15 further comprising an elongated panel protruding from the first wall of the air discharge part, wherein the elongated panel is oriented substantially perpendicular to the first row of ribs.

17. The washing machine of claim 13 further comprising an electricity supply device operable to be coupled to an external power source, wherein the electricity supply device is disposed on an opposite side of the washing machine to the accommodation part.

18. The washing machine of claim 13, wherein the drying system is configured to heat air to generate the air flow.
